(19) United States
(12) Patent Application Publication
(10) Pub. No.: US 2007/0008127 A1
(43) Pub. Date: Jan. 11, 2007

(54) Mobile communication device with a fail-safe alarm button

(75) Inventor: Kent Jakobsen, Jyllinge (DK)

Correspondence Address: OLIFF & BERRIDGE, PLC, P.O. BOX 19928, ALEXANDRIA, VA, 22320, US

(73) Assignee: KJ MOBILES, Jyllinge (DK)

(21) Appl. No.: 11/439,961

(22) Filed: May 25, 2006

(30) Foreign Application Priority Data
May 26, 2005 (DK) PA200301731

(51) Int. Cl. G08B 13/14

(52) U.S. Cl. 340/568.1

(57) ABSTRACT

The invention relates to a device and a method for fail-safe alarm comprising a mobile communication device comprising a front, a back and an alarm button, wherein said alarm button may be displaced in a displacement motion in a predetermined direction to activate an alarm; said alarm button comprises a key, said key being activated by a force substantially perpendicular to said front of said mobile communication device; and said key need to be activated to enable said displacement of said alarm button. Hereby is achieved, among other things, to protect said device from generating false alarms. It is further achieved to allow for a reflex-controlled activation of said alarm button. It is further achieved to allow both left- and right-handed individuals to use said device

### FIELD OF INVENTION

The invention relates generally to a mobile communication device comprising a front, a back and an alarm button.

### BACKGROUND OF THE INVENTION

Since 1960 and up till today the number of violent crimes committed in the US alone has almost increased by a factor of five (data taken from http://www.disastercenter.com/crime/uscrime.htm). In 2004, there were 1,367,009 counts of violent crimes reported in the US alone, this number covering murder, forcible rape, robbery and aggravated assault crimes. Therefore, the need for a fast and effective alarm-opportunity during a violent crime and other similar circumstances has increased dramatically during the last couple of decades.

Today all alarm calls are directed from the user/victim to a 911 call-centre (in Europe from a user/victim to a 112 call-centre). In some situations this method is not expedient and may yield problems such as
the user/victim can not dial up the 911-number because the user/victim is prevented from dialling the number by an assailant;
the user/victim has forgot the 911-number in a stressed and/or panicked situation such as in a violent crime;
the user/victim has forgot how to use the communication device in a stressed and/or panicked situation such as in a violent crime;
the communication device is turned of or the battery has been discharged in the time leading up to a violent crime situation;
the user/victim cannot find the alarm button on the device e.g. in a low light situation.

In the abovementioned situations the alarm central/911 call-center may not be able to supply the user/victim the correct help since it may not be possible for the alarm central to obtain the relevant information from the user/victim. Such information may comprise address of the user/victim, the situation/problem, the name of the user/victim, location, etc.

Another problem of the present day mobile communication devices (e.g GSM and UMTS networks) may be the time it takes to perform a call from a user/victim to an alarm central. Today the connection of an alarm call may take as long as 10 seconds or more which may be an unacceptable time-frame in the case of an emergency/violent crime situation.

Further, it must be ensured that the problem of false alarms caused by a user/victim using the mobile communication device, e.g. by false activation of an alarm button on said mobile communication device, is eliminated and/or reduced.

A further problem of present day mobile communication devices is that they do not support the actions of a person in a stressed or panicked situation said actions may be more or less automatically controlled by user's/victim's brain through reflexes and not through consciously controlled actions.

Several prior art solutions have been proposed in order to solve the abovementioned problems:

US 2002/0183037 describes a system comprising a panic button for making an alarm call. The alarm button is not secured from generating false alarms and/or false activation of said button and it does not support a reflex-controlled activation of the panic button which may be used in a stressed/panicked situation. Furthermore, the panic button is difficult to find in low light situations since it has not been worked out for easy finger-recognition.

GB 2,386,795 describes a system comprising an alarm button. Said alarm button is not placed so that it supports a reflex-controlled activation and further said alarm button has not been worked out for easy finger recognition e.g. in low light situations. Further, said device is not protected against generating false alarms.

JP 09-270078 describes a mobile communication device comprising an alarm button placed on a side (not front or back) of said device. Therefore, said button has not been placed such that it supports a reflex-controlled activation of said button e.g. where a thumb naturally would be placed on said device when gripped by a user/victim. In order for a user/victim to activate said alarm button the person needs to move a thumb whereby the grip may be loosened with the risk of loosing said mobile communication device or allowing an assailant to rather easy pull the device out of the hands of the user/victim. It is further not described how to protect the device against generating false alarms. Further, it is not described how to recognize said alarm button in low light situations.

US 2003/0083020 describes a mobile communication device comprising finger ridges for ensuring an unambiguous placement of said device in the hand of a user/victim and it is further disclosed that an alarm button may be made tactile. Said ridges do not allow the device to be adapted to an individuals hand size e.g. S, M, L, XL, XXL, etc. in such a way as to ensure that the thumb of said user almost automatically will be placed at or near an alarm button. According to the abovementioned piece of prior art it is only possible to adapt said device to the hand size of a user by changing the housing of the device. This clearly increases the cost of said device. Further, abovementioned piece of prior art does not disclose the fabrication of said ridges in a material which is not slippery and which may not contain allergens. Further it is not disclosed how to protect the device against false alarms. Further, it is not disclosed how the device will be able to support a reflex-controlled activation of said button.

JP 2000/0322678 describes a mobile communication device comprising two buttons for in an emergency to contact either police (left button) or fire department (right button). Said two buttons are placed between a display and a keyboard. Said buttons are not sliding buttons i.e. may not be displaced in a direction and said buttons do not comprise a key for prevention of false activation of the buttons. Further, said buttons are not placed in such a way as to allow for a reflex-controlled activation of said buttons.

DE 19959028 describes a mobile communication device comprising a push button. Said push button is only secured against false alarm activations by an inertness of said button. Said button is placed on the top of said device and it is placed so that it is visible. Thus said button will extend above the housing of the device and therefore there will be a risk of false activation of said button if e.g. the device is dropped and thereby false alarms may be generated by the device. Further, it is possible to cancel a started alarm which may be used by an assailant to disrupt the tracking of said device. Further, the reflex-controlled activation of said button is not supported.

Therefore, the problem of properly protecting said device against generating false alarms e.g. false activation of an alarm button still exist together with the problem of how to ensure the possibility of a reflex-controlled activation of said alarm-button e.g. during a reflex-controlled gripping function of said device in a violent situation or other type of stressed/panicked situation.

### SUMMARY OF THE INVENTION

It is an object of an embodiment of the present invention to provide a mobile communication device solving the abovementioned problems. More specifically it is an object of the present invention to provide a solution for the problem of protecting said device from generating false alarms. It is further an object of the present invention to provide means for solving the problem of allowing a reflex-controlled activation of said alarm button. A further object of the present invention is to solve the problem of allowing finger-recognition of said alarm button. Another object of the present invention is to solve the problem of allowing both left- and right-handed individuals to use said mobile communication device, more specifically to use the alarm button of said device during a reflex-controlled gripping function. A further object of the present invention is to solve the problem of allowing individuals with difference hand-sizes to use the mobile communication device.

The present invention solves among other things the abovementioned problems by a mobile communication device comprising a front, a back and an alarm button, wherein
said alarm button may be displaced in a displacement motion in a predetermined direction to activate an alarm;
said alarm button comprises a key, said key being activated by a force substantially perpendicular to said front of said mobile communication device; and
said key need to be activated to enable said displacement of said alarm button.

The mobile communication device solves the problem of protecting said device from generating false alarms. This effect is achieved by having an alarm button that may be displaced in a direction in order for the button to activate an alarm. Further, said button comprises a key and said key needs to be activated by a force substantially perpendicular to said front of said device to enable said button to be activated by a displacement in a direction.

This ensures that said alarm button is only activated if first said key is pressed and secondly said button is displaced. Alternatively or additionally said key may be activated simultaneously with the displacement of said alarm button. Thereby the alarm button is effectively protected against false activation and thus the mobile communication device is effectively protected against generating false alarms.

Said alarm button may be any type of button, e.g. said alarm button may be a sliding-button. Alternatively or additionally said alarm button may be a push-button. Alternatively or additionally said alarm button may be a pull-button.

Said alarm button may have any form e.g. it may have a cross-sectional area chosen from the group of square, rectangular, circular, elliptical, or any other form. The alarm button may for example have a rectangular cross-sectional area and may extend a certain height above said front of said mobile communication device e.g. 1 mm above said front. Alternatively the alarm button may be raised substantially more than 1 mm above said front of said mobile communication device.

The alarm button may have any size e.g. the alarm button may for example be substantially of the same size as the average sized button on a mobile phone. Alternatively the size of said alarm button may be substantially larger than the average mobile telephone button.

Said alarm button may be displaced in any way e.g. said alarm button may be displaced in a direction lying in the plane comprising the front of said mobile communication device. Alternatively or additionally said alarm button may be displaced in a direction perpendicular to a plane comprising said front of said mobile communication device.

Said key comprised by said alarm button may be any type of key that may be comprised by said alarm button. E.g. said key may be a push-key of any size smaller than said alarm button. Alternatively or additionally said key may be of a size smaller than said alarm button and of a size which reduces the risk of accidental activation of said key.

Said key may be activated by applying a force to said key, said force being substantially perpendicular to a plane comprising said front of said mobile communication device e.g. said key may for example become activated by a user pressing the key down towards said front of said mobile communication device. Alternatively or additionally the force used to activate said key may have a component in a direction not being perpendicular to said front of said mobile communication device.

In one embodiment the alarm button is placed on a centre-line on said front of said mobile communication device. Alternatively or additionally said alarm button is place between a display and a keyboard of said mobile communication device.

Thereby said alarm button is easily accessible for both left- and right-handed individuals since said alarm button is placed on the centerline (possibly being placed between a display and a keyboard). In the same time the alarm button may be easily activated in a stressed/panicked situation since it is situated in a place where e.g. a thumb of the user/victim may naturally be placed in a reflex-controlled gripping function thereby allowing for a reflex-controlled activation of said alarm button.

In a further embodiment said alarm button is made tactile. A tactile alarm button allows for easy finger-recognition of said alarm button, also in low light situations.

In a further embodiment said alarm button is a sliding button. A sliding button may reduce the number of accidental alarms because a sliding motion is probably less likely to occur by accident than an e.g. pushing motion. For an example in a pocket of a user/victim an accidental activation of an alarm button by a sliding motion is less likely to occur than an accidental activation e.g. by a pushing motion.

In a further embodiment said alarm button comprises an inertness in said displacement motion of said alarm button. An inertness in the displacement of the alarm button may reduce the risk of false activation of said alarm button since a certain force is required in the activation of said alarm button. Said required force may be of a magnitude that may be presented by children and/or elderly people.

In a further embodiment said mobile communication device comprises at least one spacer, said at least one spacer being of such a character that when used together with said mobile communication device the device may be customized to a user's hand-size. By adding and/or removing spacers to the mobile communication device it is possible to accommodate a plurality of different hand-sizes because an addition of a spacer may increase the size of the mobile communication device and the reduction of a spacer may decrease the size of the mobile communication device. The use of spacers allows for individuals of different hand sizes to use the mobile communication device by allowing the spacers to be exchanged and/or changed according to the hand-size of the individual using said mobile communication device. Further said spacers allow for a cheap and easy way of customizing said mobile communication device to the person using it by custom-making the outer physical dimensions of said mobile communication device to suit the individual using the mobile communication device. Further said spacers allow the user's thumb to automatically be placed on said alarm button in a reflex-controlled gripping function because the size of the mobile communication device may be tailor-suited to the hand-size of the user.

In a further embodiment said at least one spacer comprises at least one finger ridge. A spacer comprising one finger ridge on the left side of the mobile communication device (e.g. to accommodate a thumb) and a spacer comprising four finger ridges on the right side of the mobile communication device (e.g. to accommodate the four fingers not being the thumb) will allow the mobile communication device to be customized to left-handed persons improving their grasp of the device. A spacer comprising one finger ridge on the right side of the mobile communication device and a spacer comprising four finger ridges on the left side of the mobile communication device will allow the mobile communication device to be customized to right-handed persons improving their grasp of the device. The spacer(s) comprising finger ridge(s) also increases the likelihood of a user/victim using the mobile communication device automatically will have his/hers finger/thumb being placed on the alarm button for a fast and effective activation of said alarm button. Thus, said at least one spacer comprising at least one finger ridge may be of such a character that when used together with said mobile communication device, a thumb of a user using said mobile communication device will substantially be placed on said alarm button. Thereby the mobile communication device may support a reflex-controlled gripping-function of said mobile communication device.

In a further embodiment said mobile communication device comprises means for preventing said alarm from being stopped after said displacement of said alarm button. Thereby an assailant is prevented from stopping the alarm and thereby also from stopping e.g. tracking of the device. Said means for said alarm from being stopped may e.g. be physical, electrical and/or software means.

In a further embodiment said mobile communication device comprises a split preventing said alarm button from being returned from an alarm position after said displacement motion of said alarm button. Thereby the user of the mobile communication device may be reassured that an alarm has been sent to the authorities because the alarm button may not be substantially moved away from the alarm position it has been placed in after said displacement of the alarm button.

In a further embodiment said mobile communication device comprises a sound generator for generating a high frequency sound audible by at least one type of mammal. Thereby the mobile communication device may generate a sound audible to e.g. dogs which may assist the authorities in the tracking of the user/mobile communication device.

In a further embodiment said high frequency sound may be chosen from the group of frequencies: above 22 kHz, above 25 kHz, above 30 kHz, and above 35 kHz Thereby the frequency of the high frequency sound may be chosen from a group of frequencies inaudible to humans. By using a frequency inaudible to humans the mobile communication device may prevent the assailant from discovering that the high frequency sound is being generated.

In a further embodiment said mobile communication device comprises a Bluetooth communication port through which said mobile communication device may communicate with other Bluetooth devices. A Bluetooth communication port may be used by the mobile communication device for communication with other Bluetooth devices such as a Bluetooth GPS unit, a Bluetooth headset, a Bluetooth bracelet as described below, etc.

In a further embodiment said mobile communication device comprises information about a user of said mobile communication device to assist an authority determining an identity of said user. Thereby the mobile communication device may be able to transmit information about the user to an authority which may assist in the identification of the user/victim and/or help in the location of the user/victim.

Embodiments of the present invention also relates to a method.

More specifically, the invention relates to a method for activating an alarm button on a mobile communication device comprising a front, a back and an alarm button, the method comprising
displacing in a displacement motion in a predetermined direction said alarm button to generate an alarm;
said alarm button comprises a key; and
said displacing of said alarm button requires applying a force in a direction substantially perpendicular to said front of said mobile communication device to said key.

Advantageous embodiments of the method are defined in the sub-claims and described in detail in the following.

### BRIEF DESCRIPTION OF THE DRAWINGS

FIG. 1 represents a schematic drawing of a mobile communication device.

FIG. 2 represents a schematic drawing of a mobile communication device comprising an alarm button.

FIG. 3 represents a schematic drawing of system in which a mobile communication device transmits an alarm.

FIG. 4 represents a schematic drawing of a mobile communication device comprising location equipment.

FIG. 5 represents a schematic drawing of a mobile communication device comprising spacers.

FIG. 6 represents a flowchart comprising actions performed by a mobile communication device during an alarm situation.

### DETAILED DESCRIPTION OF THE INVENTION

In the following detailed description of exemplary embodiments of the invention, reference is made to the accompanying drawings which form a part hereof, and in which is shown by way of illustration specific exemplary embodiments in which the present invention may be practiced. These embodiments are described in sufficient detail to enable persons skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

In the drawings, like reference signs refer to like or corresponding elements, components, features, etc.

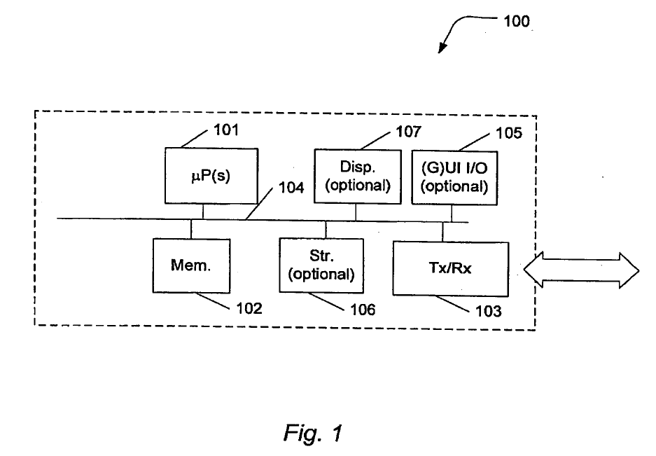

In FIG. 1 a schematic drawing of an embodiment of a mobile communication device is presented. Shown is a device (100) comprising one or more micro-processors (101) connected with a main memory (102) and optionally one storage device (106) via an internal data/address bus (104) or the like. Additionally, the device (100) may also be connected to or comprise a display (107). Additionally or alternatively the mobile communication device may comprise communication means (103) for communication with one or more remote systems and/or one or more mobile communication devices via a network. The network may be a GSM or UMTS network or the like or any other type of network. The communication means may comprise an antenna or the like. Alternatively or additionally the device may communicate directly with another mobile communication device through e.g. IR or Bluetooth communication.

The memory (102) and/or the optional storage device (106) are used to store and retrieve the relevant data together with executable computer code for providing the functionality according to the invention. The micro-processor(s) (101) is responsible for generating, handling, processing, calculating, etc. the relevant parameters according to the present invention.

The storage device (106), which may be optional, comprises one or more storage devices capable of reading and possibly writing blocks of data, e.g. a USB-slot for memory cards, DVD, CD, optical disc, PVR, etc. player/recorder and/or a hard disk (IDE, ATA, etc), floppy disk, smart card, PCMCIA card, etc.

Alternatively or additionally the mobile communication device (100) may comprise a (graphical) user interface input/output (G)UI I/O (105). The user interface input/output may comprise a keyboard. Said keyboard may be any type of keyboard such as an alpha-numeric keyboard known from standard PC computers or it may be a numeric keyboard known from standard mobile phones. The keyboard may be a physical keyboard comprising keys or the keyboard may be a virtual keyboard for use with e.g. a pen as known from Personal Digital Assistants. Alternatively or additionally said keyboard may be a combination of a physical and a virtual keyboard. Alternatively or additionally the keyboard may comprise an alarm button. Alternatively or additionally said alarm button may comprise a key.

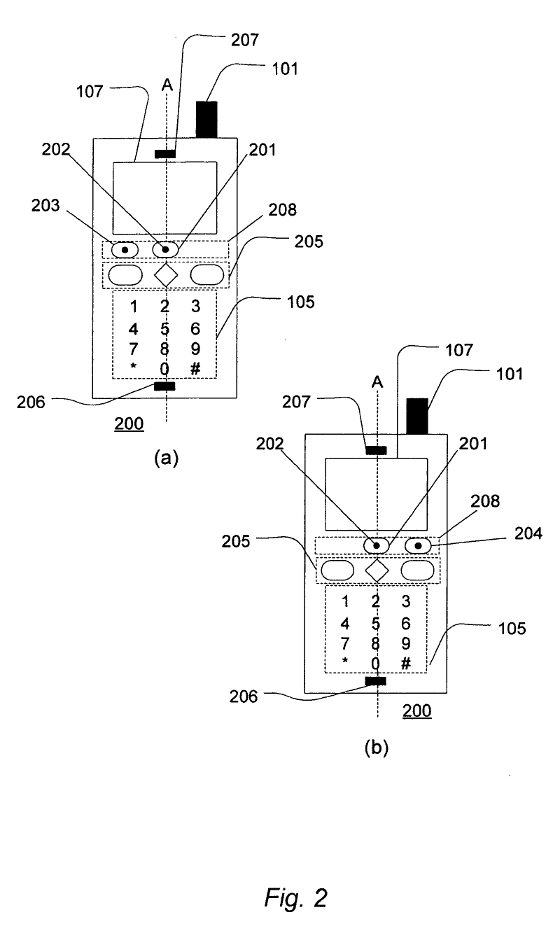

In FIG. 2 a schematic drawing of an embodiment of a mobile communication device is presented. Shown is a device (200) comprising an antenna (101), a numeric keyboard (105), some special keys (205), a microphone (206), a speaker (207) and a display (107). Further the mobile communication device may comprise an alarm button (201), said alarm button comprising a key (202). The alarm button may be any type of button such as a sliding button, a push button, a pull button or the like. In the example given in FIG. 2 the button is carried out as a sliding button. The sliding button in this example is placed between the keyboard (105) and the display (107) but generally the alarm button may be placed anywhere on the mobile communication device.

Further the sliding button (201) in this example is placed on the centre-line (A) running down through the front of the device. When said alarm button is placed on said center-line said alarm button may be in an initial position. The sliding button may slide to the left as illustrated by (203) in FIG. 2 (a) and/or to the right as illustrated by (204) in FIG. 2 (b). Generally a sliding button (201) may slide left and/or right as indicated by the possible sliding area (208) of FIG. 2. Thereby the alarm button may be used by both right- and left-handed individuals since the persons thumb substantially will be placed on the alarm button (201) when the mobile communication device is grasped, e.g. in a reflex-controlled gripping function. The device may be grasped e.g. in an emergency situation or in any other type of situation and the thumb of the user will be likely to be placed onto the alarm button during such a gripping function. In this example the sliding button is placed between the display (107) and the keyboard (105) and on the centre-line (A) but generally the alarm button may be placed anywhere on the mobile communication device. Additionally or alternatively the alarm button may be placed anywhere on the mobile communication device where it supports a reflex-controlled gripping function of the user/victim i.e. on the center-line (A).

A right-handed person will activate the alarm button by activating the key (202) and sliding the alarm button (201) to the left side of the mobile communication device seen from the front as illustrated in FIG. 2 (a), position (203). A left-handed person will activate the alarm button by activating the key (202) and sliding the alarm button (201) to the right side of the mobile communication device as seen from the front as illustrated in FIG. 2 (b), position (204).

A requirement for being able to slide the alarm button (201) is that the key (202) is activated by applying a force with a direction substantially perpendicular to the front of the mobile communication device (substantially into or out from the paper) onto the key (202). The application of a force substantially perpendicular to the front of the mobile communication device may be performed e.g. by depressing said key down towards said front of said mobile communication device. The activation of the key (202) may be performed before and/or during the sliding of alarm button (201). Thereby the mobile communication device is protected against generating false alarms since an activation of the key (202) is required for activating the alarm button (201). Additionally or alternatively the alarm button may be protected against false alarms by having an inertness built into the sliding function e.g. a certain minimum required force along the direction of the sliding motion may be required in order to allow the alarm button to slide from its initial position (e.g. on the center-line (A)) to an alarm position (203, 204). The inertness may be of a size such that a child and/or an elderly person can activate the alarm button by sliding it to alarm position (203) and/or position (204) from an initial position (A).

A depressing of said key (202) and a sliding of said alarm button (201) will in many cases automatically happen in a stressed or panicked situation in which a user grasps the device due to the placement on the alarm button at e.g. at an initial position (A). The thumb of the user will in such a situation in most cases substantially be placed on the alarm button comprising a key. Further, in a reflex-controlled gripping function the person performing the gripping action will perform i with such a force (due to the stressed/panicked situation of e.g. a violent crime) that the key (202) will become depressed and the alarm button (201) slide into the alarm position (203/204). Therefore a user in a stressed or panicked situation will be able to activate the alarm button without the requirement of a conscious act. Thereby the mobile communication device supports a reflex-controlled activation of said alarm button.

Alternatively or additionally the alarm button may be activated by a conscious act. Alternatively or additionally the activation of said alarm button may be performed in any situation.

In order to be able to distinguish the alarm button (201) from the other buttons/keys of the keyboard (105, 205), the alarm button (201) may be made tactile. Thereby a user may locate the alarm button in low light situations (and/or complete darkness) without the use of light sources. The tactile execution of the alarm button may comprise giving the alarm button a different shape than the other buttons/keys of the keyboard e.g. by giving it a rectangular cross section while the rest of the keys have square cross sectional areas. Alternatively the alarm button may have circular cross sectional area while the rest of the keys/buttons of the keyboard may have rectangular cross sectional areas. Alternatively or additionally the alarm button (201) may have a surface clearly distinguishing it from the other keys/buttons e.g. the alarm button may have a rough surface while the rest of the keys/buttons (105, 205) may have smooth surfaces. Alternatively or additionally the alarm button may be made from a soft material while the rest of the keyboard may be made from a hard material.

Alternatively or additionally the alarm button (201) may comprise a light source such as a LED so that the alarm button (201) may be used to locate the mobile communication device (200) in a bag or in low light situations.

Once the alarm button (201) has been activated by sliding the alarm button into position (203) and/or position (204), an alarm may be activated.

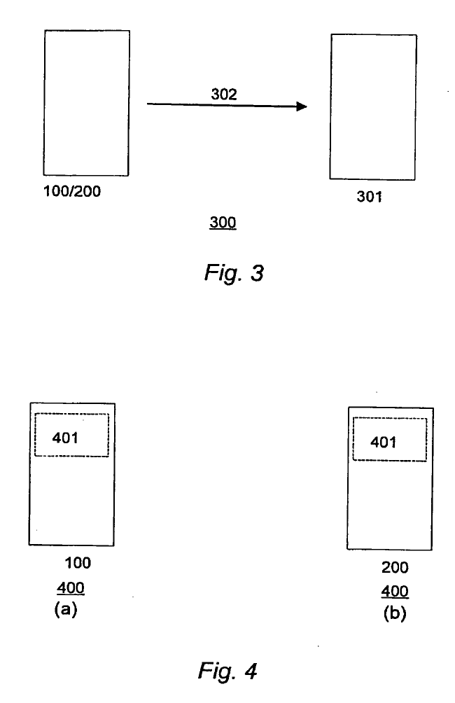

The activated alarm may be programmed to make the mobile communication device transmit an alarm (302) to the authorities (301) e.g. sending a voice message to a 911 call central in the US as illustrated in FIG. 3.

FIG. 3 represent a schematic drawing of an embodiment of a system for transmitting an alarm to an authority. Shown is a system (300) comprising a device (100, 200), an alarm call centre (301) and an alarm (302). In the system (300) a mobile communication device (100, 200) has an alarm button which has been activated and the mobile communication device transmits an alarm (302) to the alarm call centre (301). Alternatively, a mobile communication device (100, 200) has an alarm button which has been activated, thereby activating an alarm function, said alarm function comprises making the mobile communication device transmit an alarm (302) to the alarm call centre (301).

The alarm (302) may comprise an alarm voice message and/or an SMS alarm message and/or alarm data. An alarm voice message may comprise information about the user and that an alarm situation is occurring or eminent. The alarm voice message may for example be a voice message recorded prior to the alarm situation. If an alarm voice message is transmitted to the authorities, the mobile communication device automatically dials the alarm central number (e.g. 911 in the USA) and transmits the voice message when connected e.g. together with location information possibly obtained from a piece of localization equipment as described below. A Short-Message-Service (SMS) alarm message may comprise an alarm text e.g. together with location information (see below) and/or user information and may be transmitted (302) to the authorities/alarm call center (301) from the mobile communication device comprising the alarm button (200). If an SMS alarm message is transmitted to the authorities, the mobile communication device automatically fills in the information required by an SMS message, e.g. number of the receiver (911) and the message to transmit (e.g. name of the user/victim together with a text-string describing that an emergency situation is occurring) and transmits the SMS message to the authorities e.g. together with location information (see below). Alarm data may comprise user information and/or the location of the user determined by e.g. GPS as described below and/or a message describing that an alarm situation is occurring or eminent and/or other information. The alarm data may be transmitted from the mobile communication device to the alarm call central e.g. by GPRS. Alternatively or additionally the use of a SMS alarm message may be used as a “fall back” system if e.g. GPRS is unavailable.

The noticing of the authorities is fast when the mobile communication device automatically dials and sends e.g. a recorded alarm voice message to the authorities in an alarm situation once the alarm button (201) has been activated compared to the situation where the user personally has to dial the alarm central and communicate the user identification data and the alarm situation, position, etc. to the authorities. Further the risk of misdialing in the stressed/panicked situation,is removed by having the mobile communication device perform the dialing.

The alarm and/or the alarm-function will be implementable in all standard communication devices and in all available communication systems (GSM, Tetra, UMTS, GPRS, PMR, etc.). The alarm and/or the alarm function will comply with the rules stipulated by the concerned system and country regarding alarm calls.

Alternatively or additionally the alarm (302) may be transmitted to a third party from where an alarm call may be transmitted to the authorities (301). For example the user/victim may subscribe to an alarm service. Once the alarm button (201) is activated, an alarm is sent to the alarm service provider and said service provider may arrange for transmission of relevant data to the authorities (301) e.g. position of the mobile communication device, user identification, etc.

The abovementioned alarm (302) ensures that the authorities are informed about an alarm situation. In order to locate the user/victim from whose mobile communication device the alarm has been transmitted, the mobile communication device (100, 200) may comprise localization equipment such as GPS, A-GPS as illustrated by (401) in FIG. 4, (a) and (b). In FIG. 4 (a), a schematic drawing of an embodiment of a mobile communication device is presented. Shown is a device (400) comprising a device (100) and further comprising localization equipment (401). In FIG. 4 (b), a schematic drawing of an embodiment of a mobile communication device is presented. Shown is a device (400) comprising a device (200) and further comprising localization equipment (401). The localization equipment (401) may be an internal part of the device (100, 200) or it may be an external device coupled to a device (100, 200) through e.g. a wire or through Bluetooth communication. Alternatively or additionally the localization of the mobile communication device transmitting said alarm may be performed by triangulation of the signals transmitted to and received from the mobile communication device e.g. to and from GSM relay stations. The precision of the localization of the mobile communication device may be better than 10 meters, alternatively or additionally better than 50 meters, alternatively or additionally better than 100 meters. Using the localization equipment the mobile communication device may transmit localization information to the authorities during an: alarm and e.g. until the alarm is terminated.

Alternatively or additionally the authorities may use the localization equipment to track the mobile communication device.

It may be possible to implement a special tracking service of the user's/victim's mobile communication device in the time period up to the mobile communication device transmits an alarm to the alarm call centre (e.g. 911). For example the user's/victim's route the last e.g. 15-60 minutes before transmission of the alarm may have been recorded either in the device memory (102) and/or storage (106) and/or at a mobile operator where the user/victim has subscribed the mobile communication device. During the alarm (302) the route/information may be transmitted to the authorities along with the alarm, the route/information being transmitted to the authorities either from the mobile communication device and/or from the mobile operator. Thereby the authorities may also be informed about the user's/victim's movement for a period of time before the alarm which may increase the precision of the localization of the user/victim/mobile communication device.

In one embodiment the alarm button (201) remains in the alarm position (203, 204) after the activation of the alarm button and thus the associated alarm and/or alarm function may not be terminated by returning said alarm button (201) to an initial position (A). This may serve as a visible proof to the user/victim that the alarms button has been activated and that an alarm has been dispatched to the authorities.

In one embodiment the alarm remains active after the activation of the alarm button (201) and the associated alarm function. A way to prevent said alarm from being stopped may be by having a physical hindrance preventing said alarm button (201) from being returned to its initial position. Such a hindrance preventing the alarm button (201) from being returned from the alarm position (203, 204) may be facilitated by a spring activated split entering into the sliding path of the alarm button (201) after said alarm button has passed said split i.e. a physical hindrance preventing said alarm button from being returned to its initial position. A physical hindrance preventing said alarm button from being returned to its initial position may also serve as a reassurance for the user that an alarm has been sent to the authorities. Alternatively or additionally the alarm may be prevented from being stopped by a software hindrance such as a software program being started when said alarm button (201) is activated and said software program may for example deactivate the keyboard (105) and/or said alarm button (201) and/or the signals being generated by said keyboard (105) and/or said alarm button (201). Alternatively or additionally the alarm may be prevented from being stopped by an electrical hindrance such as an electrical loop being closed by the alarm button (201) in the alarm position (203, 204) but said electrical loop not being affected (i.e, not being opened) by a return of the alarm button to its initial position. Thus a person with special tool(s) may be required to terminate an alarm. Said tool(s) may be a mechanical tool (e.g. screwdriver), a software tool (e.g. a program resetting said mobile communication device to factory settings) and/or an electrical tool (e.g. an electrical system opening said closed electrical loop). Alternatively or additionally a user code may need to be entered into the mobile communication device in order to terminate said alarm. By preventing the alarm from being terminated without the user of special tool(s) and/or a code prevents the user from repeated misuse of the alarm function since the communication device may require a mechanical measure to make the mobile communication device function normally again after an activation of the alarm button (201).

In one embodiment the communication device is programmed to switch to a condition in which necessary functions, such as the location equipment and microphone e.g. for recording the violent crime, remain active after the alarm button (201) has been activated (203, 204) whereas all other functions, such as display and keyboard, are deactivated. The abovementioned condition may be performed in order to save energy. Thereby the time which the mobile communication device may transmit information, e.g. position and sound data, to the authorities may be increased. Further the condition prevents an assailant from turning off the device in which case the alarm and the tracking of the device may be terminated.

In one embodiment the mobile communication device comprises equipment for monitoring the battery condition e.g. monitoring if the battery is going to be drained of energy. Said monitoring equipment may comprise a current gauge and/or voltage gauge and/or any other type of battery monitor. The battery monitor may inform the user/victim about a required recharging of said battery and/or inform the user about the remaining battery time. Additionally or alternatively the mobile communication device may be constructed in such a way as to be automatically turned off when a certain lower limit of battery life time is remaining e.g. the device is automatically turned off when only two hours of battery lifetime remains thereby ensuring a certain lower limit of device operation in alarm mode e.g. two hours.

In one embodiment the mobile communication device is constructed such that the alarm button (201) may be activated and an alarm (302) may be transmitted to the authorities (301) when the device is turned off. This may be ensured by letting the alarm button have a dual functionality: Acting as an alarm button and acting as an on-button, whereby the mobile communication device may be turned on (in the case it was turned off prior to the activation of the alarm button) and an alarm/alarm function activated substantially simultaneously with the start-up of the turned-off mobile communication device.

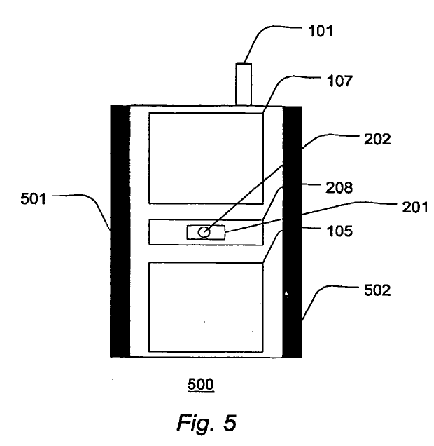

In one embodiment the mobile communication device may take the hand-size of the user into account. In FIG. 5 a schematic drawing of a mobile communication device is presented. Shown is a device (500) comprising an antenna (101), a display (107), a keyboard (105), a sliding area (208), an alarm button (201) and a key (202). The mobile communication device further comprises a left spacer (501) and a right spacer (502). Alternatively or additionally spacers (501) and (502) may be one item. The spacers (501) and/or (502) may be constructed in a non-slippery material. Alternatively or additionally the material of the spacers may be organic. Alternatively or additionally said spacers may be made in a material that is amicable to humans. By use of the spacers the size of the mobile communication device may be altered to suit the hand size of the individual using the mobile communication device. The spacers may be placed on/around the mobile communication device as a holster which may be drawn up and around the mobile communication device. Alternatively or additionally the spacers may be fixed to the mobile communication device using screws. Alternatively or additionally the spacers may be fixed to the mobile communication device using a click-on system. Alternatively or additionally the spacers may be fixed to the mobile communication device using an interlock system which locks the spacers and the mobile communication device together. Alternatively or additionally said spacers (501, 502) may comprise finger ridges for a better support of the user's hand. To support a left-handed person, the spacer (501) may comprise a single finger ridge suited for the thumb and the spacer (502) may comprise four finger ridges suited for the four remaining fingers. To support a right-handed person, the spacer (502) may comprise a single finger ridge suited for the thumb and the spacer (501) may comprise four finger ridges suited for the four remaining fingers. The spacers may increase the mobile communication device's support for the natural gripping function of the individual using the mobile communication device by customizing the size of the device to the person-and by supplying finger ridges for an improved grip. The spacers may also increase the speed with which the user may locate and activate the alarm button (201) in a reflex-controlled gripping function of the mobile communication device by supplying the user with a better grip around the device. Additionally or alternatively said reflex-controlled gripping function of said mobile communication device comprising spacers comprising finger ridges substantially placing e.g. a thumb of the user on the alarm button thereby enabling a fast and easy activation of said alarm button.

In one embodiment the communication device may be fabricated in a substantially robust and/or substantially watertight material whereby the mobile communication device can function in wet weather and/or resist shocks e.g. from being thrown to the ground.

In one embodiment the battery of the communication device may only be removed by a special type of tool. This will protect the mobile communication device from having an assailant remove the battery and thereby end the alarm and the tracking of the user/victim.

In one embodiment the person purchasing the mobile communication device may fill out a form comprising information about the person e.g. the persons name and address. This information may be tied to the identification information of the mobile communication device such as MS_ISDN, IMSI, IMEI, etc. and the information may be registered and stored in the memory (102) or storage (106) of the mobile communication device. The information may then be made available to the authorities in the case of an alarm call made from the mobile communication device e.g. by letting the mobile communication device transmit the information to the authorities together with or after an alarm call. Alternatively or additionally the authorities may retrieve the data from a central database using an IMEI, IMSI and/or MS-ISDN identification number transmitted from the mobile communication device. By tying user-information to e.g. IMEI prevents the use of e.g. a SIM card from another mobile communication device to create a false alarm on the device in which user-data are stored via e.g. the IMEI number.

In one embodiment it is possible to further store e.g. the following information:
Age
Sex
Picture
Next of kin
Other contact information
Blood type
Identification marks e.g. birth marks, tattoo, etc.
Diseases
Other information

Said information may help the authorities in the alarm situation by e.g. identifying the user/victim. Further the information may help the authorities in identifying a user in the case of a misuse of the alarm function.

In one embodiment an activation of said alarm button may start a high intensity sound being generated e.g. by the speaker of said mobile communication device and/or by a special unit for high intensity sound generation such as a siren and/or any other type of sound generator. The intensity of said sound may e.g. be 120 dB. Alternatively or additionally said intensity may be any magnitude. Alternatively or additionally an activation of said alarm button may start a high frequency sound being generated e.g. by the speaker of said mobile communication device and/or by a special unit for high intensity sound generation such as a siren and/or any other type of sound generator. Said high frequency sound may be of a type which is audible for animals such as dogs. Alternatively or additionally said high frequency sound may have a frequency above 30 kHz. Alternatively or additionally said high frequency sound may have a frequency above the audible range of a human ear. Alternatively or additionally said high frequency sound may have any frequency.

In one embodiment the mobile communication device (100, 200) comprises a Bluetooth communication port (103) through which said device may send and receive signals. Such signals may be received from e.g. a bracelet worn by the user/victim. The bracelet may comprise an alarm button and a Bluetooth communication port. Said bracelet and said mobile communication device (100, 200) may communicate with each other through Bluetooth communication. By activation of the alarm button on said bracelet being in communication with said mobile communication device via Bluetooth communication, an alarm signal is transmitted from said bracelet to said mobile communication device, said signal comprising information starting an alarm and/or alarm function on said mobile communication device i.e. the activation of said alarm button on said bracelet may correspond to an activation of said alarm button on said mobile communication device (100, 200). Thereby an activation of said alarm button on said bracelet may initiate an alarm being sent from said mobile communication device (100, 200) to e.g. an alarm call central such as a 911-call center.

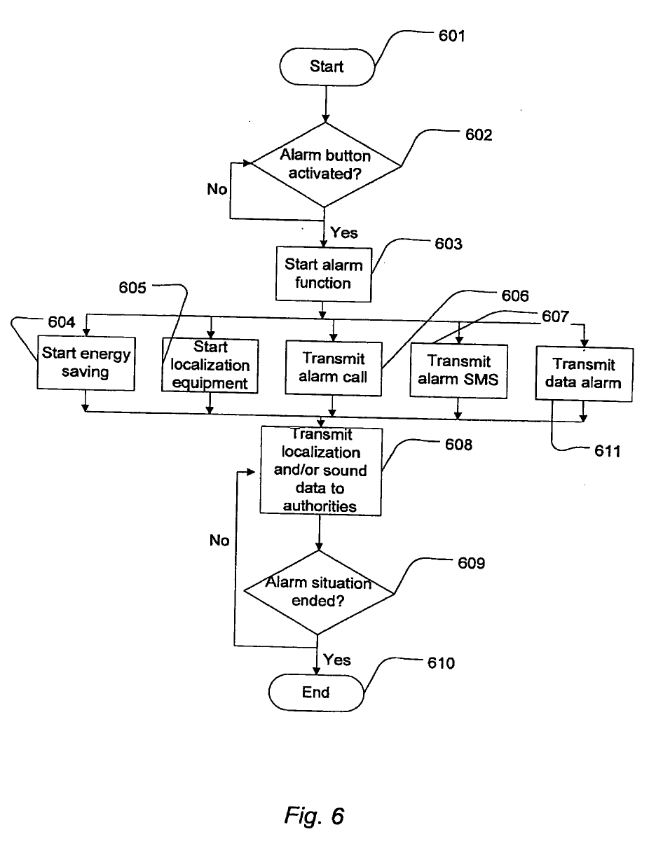

In FIG. 6 a flowchart of an alarm situation is presented. The flowchart begins in step (601). In step (602) the mobile communication device controls whether the alarm button has been activated. If the alarm button has not been activated the device does not activate an alarm function. If the alarm button has been activated the device may activate an alarm function in step (603). Alternatively the mobile communication device may transmit an alarm to the authorities directly. The alarm function (603) may start one or more processes on the mobile communication device. Such a process may be to transmit an alarm call to the relevant authority (e.g. a 911 call-central) as illustrated in step (606). Alternatively or additionally said alarm function (603) may start a process comprising transmitting an SMS comprising a alarm message to the relevant authority as illustrated in step (607). Alternatively or additionally said alarm function (603) may start a process comprising transmitting a data alarm (611) e.g. comprising location information of the mobile communication device, identification of the user starting said alarm data, a text string comprising information about an alarm situation occurring. Alternatively or additionally said alarm function (603) may start a piece of localization equipment (604) residing either on said mobile communication device or being connected to said mobile communication device via e.g. a wire and/or Bluetooth. The localization unit may be e.g. a GPS unit, an A-GPS unit or the like. Alternatively or additionally said alarm function may request a localization by triangulation from a supplier of mobile services. Alternatively or additionally said alarm function may put the mobile communication device in an energy saving state (605), where necessary pieces of equipment, such as the localization unit and the microphone, are kept active whereas other pieces of equipment, such as keyboard and display, may be deactivated. In step (608) the mobile communication device transmits localization data to the relevant authorities in order to facilitate the tracking of the user

victim being in an alarm situation. Alternatively or additionally said mobile communication device may transmit sound through the microphone of said mobile communication device. The sound may be recorded by e.g. the 911 call centre and possibly help in providing assistance to the user/victim being in an alarm situation. Alternatively or additionally said recorded sound from the mobile communication device may later help investigators in solving a violent or other crime committed. Alternatively or additionally said mobile communication device may transmit user information stored on said mobile communication device to the authorities which may help the authorities in the localization and/or identification of the user/victim. In step (609) a situation status is performed. If the alarm situation still exists (e.g. the alarm has not been terminated by for example special tools) the mobile communication device continues to transmit localization and/or sound data to the relevant authorities (608). If the alarm situation has been solved, the alarm function on the mobile communication device may be terminated e.g. by entering a security code to the mobile communication device or by a person using a special tool as described above. In step (610) the flowchart ends.

1. A mobile communication device comprising a front, a back and an alarm button, wherein
said alarm button may be displaced in a displacement motion in a predetermined direction to activate an alarm;
said alarm button comprises a key, said key being activated by a force substantially perpendicular to said front of said mobile communication device; and
said key need to be activated to enable said displacement of said alarm button.

2. A mobile communication device according to claim 1 wherein said alarm button is placed on a centre-line on said front of said mobile communication device.

3. A mobile communication device according to claim 1, wherein said alarm button is made tactile.

4. A mobile communication device according to claim 1 wherein said alarm button is a sliding button.

5. A mobile communication device according to claim 1 wherein said alarm button comprises an inertness in said displacement motion of said alarm button.

6. A mobile communication device according to claim 1 wherein said mobile communication device comprises at least one spacer.

7. A mobile communication device according to claim 6 wherein said at least one spacer comprises at least one finger ridge.

8. A mobile communication device according to claim 1 comprising means for preventing said alarm from being stopped after said displacement of said alarm button.

9. A mobile communication device according to claim 1 wherein said mobile communication device comprises a split preventing said alarm button from being returned from an alarm position after said displacement motion of said alarm button.

10. A mobile communication device according to claim 1 wherein said mobile communication device comprises a sound generator for generating a high frequency sound audible by at least one type of mammal.

11. A mobile communication device according to claim 10 wherein said high frequency sound may be chosen from the group of frequencies: above 22 kHz, above 25 kHz, above 30 kHz, and above 35 kHz.

12. A mobile communication device according to claim 1 wherein said mobile communication device comprises a Bluetooth communication port through which said mobile communication device may communicate with other Bluetooth devices.

13. A mobile communication device according to claim 1 wherein said mobile communication device comprises information about a user of said mobile communication device to assist an authority determining an identity of said user.

14. A method for activating an alarm button on a mobile communication device comprising a front, a back and an alarm button, the method comprising
displacing in a displacement motion in a predetermined direction said alarm button to generate an alarm;
said alarm button comprises a key;
and said displacing of said alarm button requires applying a force in a direction substantially perpendicular to said front of said mobile communication device to said key.

15. A method according to claim 14 further comprising a step of starting an alarm function when said displacement of said alarm button has occurred, said alarm function comprises transmitting the alarm to an authority.

16. A method according to claim 15 wherein said alarm function comprises starting at least one piece of localization equipment and/or localization by triangulation to derive the present location of said mobile communication device.

17. A method according to claim 16, comprising transmitting information representing said present location of said mobile communication device to an authority.

18. A method according to claim 14 wherein said mobile communication device transmits user information stored on said mobile communication device to an authority.
